(19) United States
(12) Patent Application Publication
(10) Pub. No.: US 2017/0120727 A1
(43) Pub. Date: May 4, 2017

(54) AIR SHOWER DEVICE AND AIR CONDITIONING DEVICE

(71) Applicants: DENSO International America, Inc., Southfield, MI (US); DENSO CORPORATION, Kariya-city (JP)

(72) Inventor: Adam Gilley, Detroit, MI (US)

(21) Appl. No.: 14/927,592

(22) Filed: Oct. 30, 2015

(51) Int. Cl. B60H 1/34; B62D 33/06; B60N 3/00; B60H 1/24; B60H 1/00

(52) U.S. Cl. CPC B60H 1/3414; B60H 1/244; B60H 1/00378; B60H 1/00564; B60H 1/00064; B60N 3/008; B62D 33/0612; B60H 2001/00092

(57) ABSTRACT

A body of an air shower device is hollow and defines an internal space. The body has an upper wall and a lower wall, which are opposed to each other. The upper wall has an opening extending though the upper wall. The lower wall has apertures extending though the lower wall. The body draws air from the opening to conduct the air through the internal space and to spray the air from the internal space through the apertures to an outside of the body.

### TECHNICAL FIELD

The present disclosure relates to an air shower device. The present disclosure further relates to an air conditioning device having the air shower device.

### BACKGROUND

Conventionally, a vehicle may include an air conditioning device to perform air-conditioning in a cabin of the vehicle. It may be preferable to enhance efficiency of air-conditioning in the vehicle.

### SUMMARY

According to an aspect of the present disclosure, an air shower device may comprise a body being hollow and defining an internal space. The body may have an upper wall and a lower wall, which are opposed to each other. The upper wall may have an opening extending though the upper wall. The lower wall may have a plurality of apertures extending though the lower wall. The body may be configured to draw air from the opening to conduct the air through the internal space and to spray the air from the internal space through the apertures to an outside of the body.

### BRIEF DESCRIPTION OF THE DRAWINGS

The above and other objects, features and advantages of the present invention will become more apparent from the following detailed description made with reference to the accompanying drawings. In the drawings:

FIG. 1 is a schematic perspective view showing a cabin of a vehicle;

FIG. 2 is a schematic side view showing the cabin;

FIG. 3 is a schematic sectional view showing an HVAC unit for the vehicle;

FIG. 4 is a schematic perspective view showing an air shower device being folded;

FIG. 5 is a schematic perspective view showing the air shower device being extended;

FIG. 6 is an exploded perspective view showing components of the air shower device;

FIG. 7 is a schematic perspective view showing the air shower device being used;

FIG. 8 is a schematic plan view showing a component of the air shower device;

FIG. 9 is a schematic perspective view showing an air shower device of a second embodiment;

FIG. 10 is a schematic perspective view showing an air shower device of a third embodiment;

FIG. 11 is a schematic plan view showing an air shower device of a fourth embodiment;

FIG. 12 is a schematic plan view showing an air shower device of a fifth embodiment;

FIG. 13 is a schematic perspective view showing a cabin of the vehicle according to a sixth embodiment;

FIG. 14 is a schematic side view showing an air shower device of a seventh embodiment;

FIG. 15 is a schematic side view showing an air shower device of an eighth embodiment; and

FIG. 16 is a schematic side view showing an air shower device of a ninth embodiment.

### DETAILED DESCRIPTION

### First Embodiment

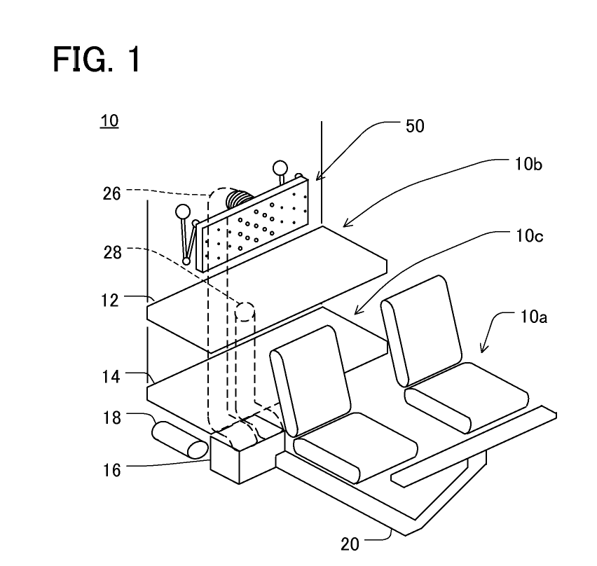

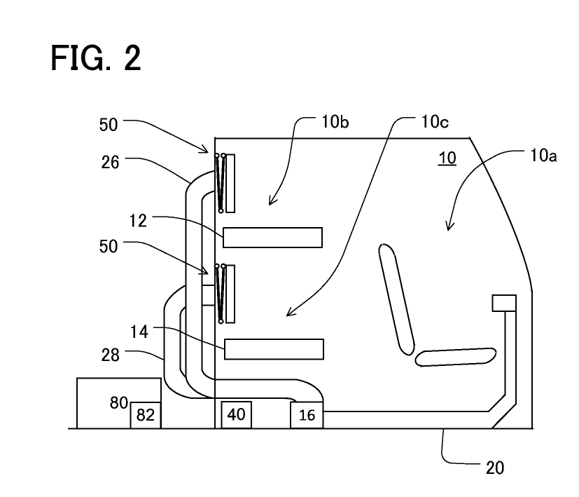

FIGS. 1 and 2 show a vehicle such as a trailer truck. The vehicle has a cab 10 having a front cabin 10a, an upper rest area 10b, and a lower rest area 10c. Both the upper rest area 10b and the lower rest area 10c are behind the front cabin 10a. An upper bed 12 and a lower bed 14 are installed in the upper rest area 10b and the lower rest area 10c, respectively.

An air-conditioning system may include a heating, ventilation, and air conditioning unit (HVAC unit) 16, a compressor 18, and ducts 20, 26, 28. The air-conditioning system is configured to perform air-conditioning in the cab 10. The air-conditioning system may further include a thermal medium pipe (not shown) between the HVAC unit 16 and the compressor 18 to conduct thermal medium. The HVAC unit 16 and the compressor 18 are, for example, located under the bed 12.

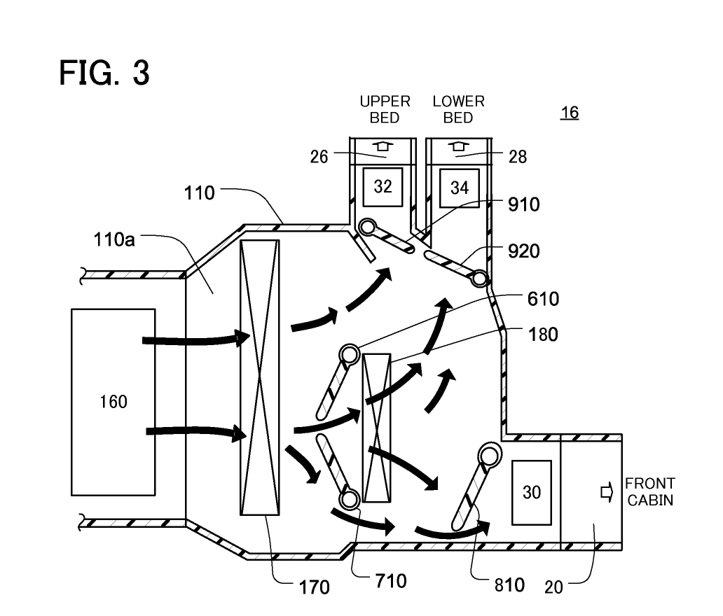

As shown in FIG. 3, the HVAC unit 16 includes a case 110 accommodating, for example, a blower 160, an evaporator 170, and a heater 180. The case 110 rotatably accommodates heater doors 610 and 710, a front-cabin door 810, an upper-bed door 910 and a lower-bed door 920, which are driven by a motor and a link (not shown).

The case 110 defines a main passage 110a communicating with an outside of the case 110. In the case 110, the blower 160, the evaporator 170, and the heater 180 may be arranged in this order relative to a flow direction of the airflow in the case 110. The front-cabin door 810, the upper-bed door 910, and the lower-bed door 920 may be equipped for the ducts 20, 26, 28, respectively.

The blower 160 is driven by a motor (not shown) to blow air through the main passage 110a and the evaporator 170 toward the heater 180. The heater doors 810 and 710 are controlled to permit airflow through the heater 180. The front-cabin door 810, the upper-bed door 910, and the lower-bed door 920 may be operable individually to control flow of conditioned air supplied through the ducts 20, 26, 28 to the front cabin 10a, the upper rest area 10b, and the lower rest area 10c, respectively.

A first fan 30, a second fan 32, and a third fan 34 may be equipped for the ducts 20, 26, 28, respectively. The fans 30, 32, 34 may boost conditioned air supplied to the front cabin 10a, the upper rest area 10b, and the lower rest area 10c, respectively. The fans 30, 32, 34 may be selectively activated, such that the at least one of the fans 30, 32, 34 is operated for an area occupied by a person.

The refrigerant cycle may be equipped with a cold storage unit 40 (FIG. 2) for storing cooled item such as a cold drink. Specifically, the cold storage unit 40 may be connected with the compressor 18 and the HVAC unit 16 via a thermal medium pipe (not shown) to conduct a thermal medium.

In FIG. 2, the vehicle may have a non-idle system (parking system) 80 equipped with an auxiliary power unit 82. Specifically, the auxiliary power unit 82 may include a high-capacity power source such as an electric capacitor.

The vehicle may be a hybrid vehicle including a motor generator to convert kinetic energy of the vehicle into an electric energy and to charge the auxiliary power unit 82 with the converted electric energy. In this case, the motor generator may be also to convert an electric energy accumulated in the auxiliary power unit 82 into a driving power.

The auxiliary power unit 82 may be configured to supply electricity for driving the compressor 18 of the air-conditioning system, the cold storage unit 40, and/or the like. The auxiliary power unit 82 may be operational regardless of whether an internal combustion engine of the vehicle is active or inactive and/or regardless of whether the vehicle is parking or travelling. The auxiliary power unit 82 may control its electricity supply according to the operational state of the internal combustion engine. The auxiliary power unit 82 may operate the fans 30, 32, 34, the compressor 18, and or the like selectively in order to supply conditioned air to the cab 10.

The upper bed 12 and the lower bed 14 may be equipped with air shower devices 50, respectively. The air shower devices 50 may have a common structure. The air shower devices 50 may be normally folded on a wall, when not being used, in order not to obstruct a user to use the rest area 10b and/or 10c. As follows, the air shower device 50 will be described.

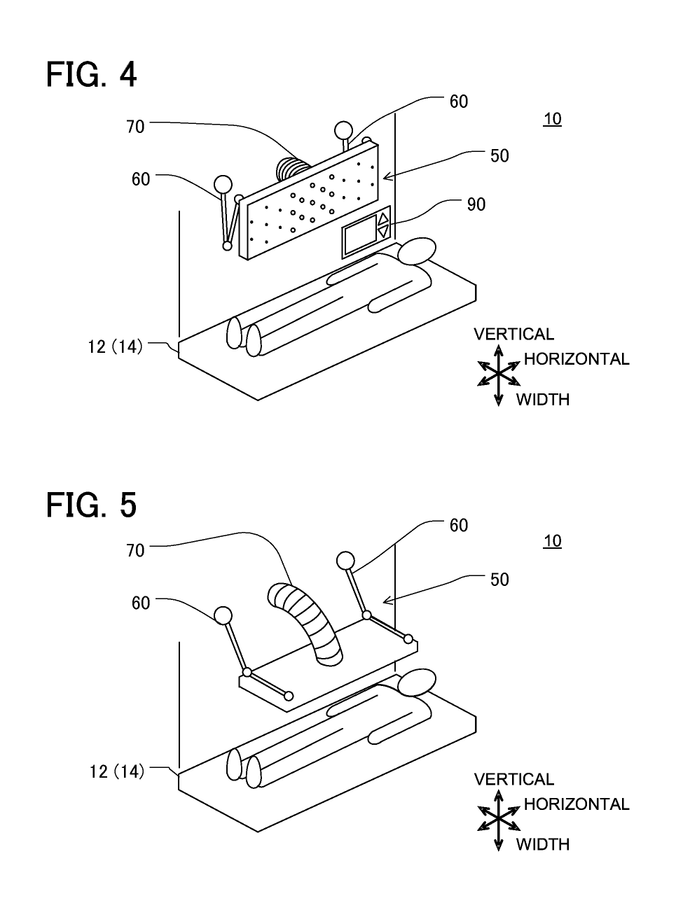

As shown in FIGS. 4 and 5, the air shower device 50 may be supported by a wall of the cab 10 via two support arms 60. Each of the support arms 60 may include, for example, universal joints having multiple movable joints. Each of the movable joints may be a ball joint or a combination of rotational joints to swing in multiple directions. The support arms 60 may enable the air shower device 50 to be folded along the wall. For example, the air shower device 50 may be normally folded on the wall when the vehicle is travelling and when the air shower device 50 is not being used. The support arms 60 may enable the air shower device 50 to be unfolded and extended from the wall. For example, when a user of the vehicle takes a rest and uses the air shower device 50, the user may unfold the air shower device 50 from the wall and may adjust the position of the air shower device 50 relative to the user. The support arms 60 may be universally movable in both the vertical and horizontal directions and may be adjusted in position relative to the bed.

The support arm 60 may be a simple hinged arm having a single axis to swing in one rotational direction along the axis. The air shower device 50 may be supported via, for example, one support arm 60 or three or more support arms 60. The support arm 60 may be electrically driven or electrically assisted.

The air shower device 50 may be connected with corresponding one of the ducts 26 and 28 through a flexible duct 70. The flexible duct 70 is, for example, a bellows pipe having a corrugated passage wall. The flexible duct 70 may be formed of resin and may be bendable. The flexible duct 70 may be expandable when the air shower device 50 is unfolded from the wall. The flexible duct 70 may be shrinkable when the air shower device 50 is folded on the wall. The flexible duct 70 may be partially or entirely retractable into a space beyond the wall. The air shower device 50 may have a coupler such as a one-touch coupling device to be coupled with the flexible duct 70. The flexible duct 70 may be configured to draw conditioned air from the HVAC unit 16 through the corresponding one of the ducts 26 and 28 into the air shower device 50.

The flexible duct 70 may be provided with the air shower device 50 as, for example, an aftermarket product. The flexible duct 70 may be connected with the corresponding one of the ducts 26 and 28 by using an adaptor attachment. The duct 26 and/or 28 may be of, for example, a ready-made car, and the air shower device 50 and the flexible duct 70 may be installed in a ready-made car by coupling the flexible duct 70 to the duct 26 and/or 28.

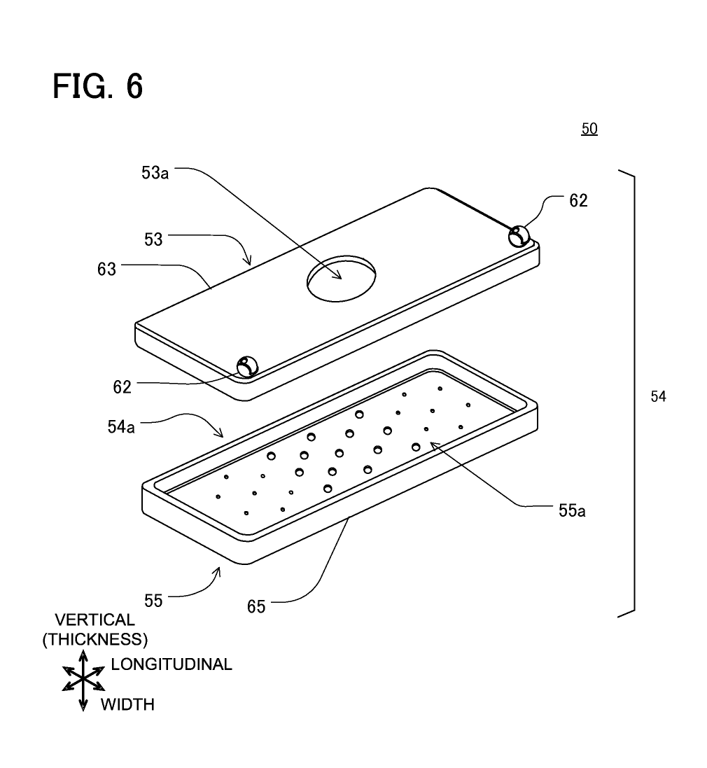

As shown in FIG. 6, the air shower device 50 has a body 54, which may be formed by combining an upper member (upper portion) 53 with a lower member (lower portion) 55. The body 54 may be, for example, a hollow box-shaped device. Each of the upper member 53 and the lower member 55 may be in a rectangular bottomed tray shape having a U-shaped cross section. The upper member 53 may have couplers 62 via which the upper member 53 is coupled with the support arms 60. The support arms 60 may be screwed to the couplers 62, respectively. The upper member 53 may have an upper wall 63 defining an opening 53a. The opening 53a may be coupled with the flexible duct 70. In the present example, the opening 53a is located in a center portion of the body 54. The lower member 55 has a lower wall 65 having multiple apertures 55a. Each of the apertures 55a may be a thoughhole extending through the lower wall 65 of the lower member 55. The upper member 53 and the lower member 55 combined with each other form the body 54 being a hollow member. The body 54 may be in a flat planer shape extending in the width direction and the longitudinal of the body 54. The body 54 may be configured to conduct air from the flexible duct 70 through an internal space 54a of the body 54 in the width and longitudinal directions. The body 54 is formed of, for example, resin such as polycarbonate.

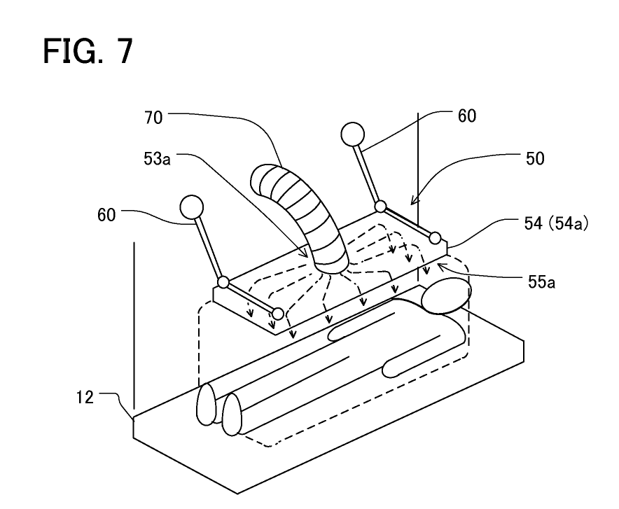

A shown in FIG. 7, the body 54 may draw air from the flexible duct 70 through the opening 53a and conducts the air through the internal space 54a of the body 54. Thus, the body 54 may spray the air from the internal space 54a through apertures 55a to the outside of the body 54.

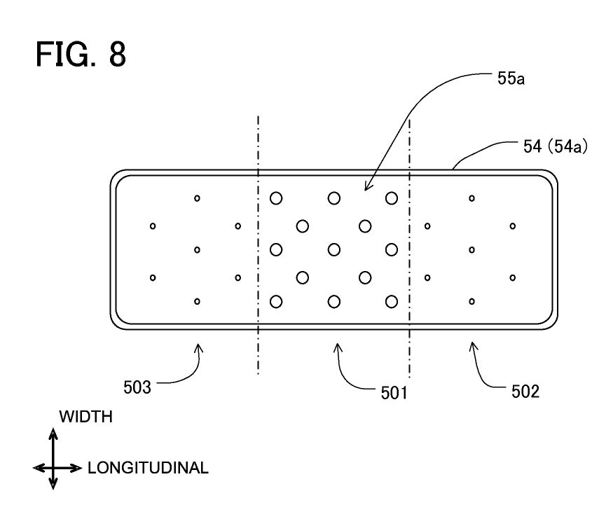

As shown in FIG. 8, each of the apertures 55a may be in a circular shape having a diameter in a range between, for example, 1 millimeter and 10 millimeters. Each of the apertures 55a may extend perpendicularly to the thickness direction of the lower wall 65. Each of the apertures 55a may be angled relative to the thickness direction of the lower wall 65. For example, an aperture 55a located distant from a center portion 501 of the body 54 may be inclined relative to the thickness direction and directed toward the center portion 501. In this way, the aperture 55a may be configured to spray conditioned air toward the center portion 501 at which a user is supposed to be located.

The apertures 55a may be distributed non-uniformly. For example, the apertures 55a may be distributed densely in a specific portion of the body 54 and may be distributed sparsely in a portion other than the specific portion. Specifically, the apertures 55a may be distributed densely in a specific portion by allocating a large number of the apertures 55a in the specific portion compared with the other portion and/or by allocating the apertures 55a each having a large diameter in the specific portion compared with the other portion. In this way, the apertures 55a may be distributed densely to spray an amount of air greater in the specific portion than an amount of air in the other portion.

For example, the air shower device 50 may be divided into three segments in the longitudinal direction and the density of the apertures 55a may be differed among the three segments. Specifically, the air shower device 50 may be divided into the center portion 501, one end portion 502 and the other end portion 503 evenly in the longitudinal direction.

In the example of FIG. 8, the apertures 55a may be distributed densely in the center portion 501 of the body 54 and may be distributed sparsely in the one end portion 502 and the other end portion 503 of the body 54, which are other than the center portion 501. Specifically, the center portion 501 has the apertures 55a greater in the diameter and/or greater in the number than the one end portion 502 and the other end portion 503. Alternatively, the apertures 55a may be distributed uniformly throughout the body 54 in the longitudinal direction and/or in the width direction.

As follows, an operation of the air shower device 50 will be described. In the present example, a user may park the vehicle and may stop the engine. The auxiliary power unit 82 may be active to supply electricity to the HVAC unit 16 and other electrical devices. A user such as a driver or a passenger of the vehicle is to take a rest in the vehicle.

Referring back to FIG. 4, the air shower device 50 may be normally folded on the wall when the user does not use the air shower device 50. That is, FIG. 4 may show a condition before the user uses the air shower device 50. The air shower device 50 may be raised along the vertical direction. The user lies on the bed.

FIG. 5 may show a condition where the user uses the air shower device 50. The user on the bed may unfold the air shower device 50 from the wall. Specifically, the user may swing the air shower device 50 by about 90 degrees relative to the wall to place the air shower device 50 in parallel with the bed 12. Thus, the air shower device 50 may be opposed to the bed 12. The user may be currently interposed between the air shower device 50 and the bed 12.

The flexible duct 70 may be expanded or drawn from the wall while maintaining communication between the air shower device 50 and the duct 26 or 28. The support arms 60 may allow the air shower device 50 to move in both the vertical and horizontal directions to allow the user to adjust the position of the air shower device 50 relative to the user. The support arms 60 may allow the air shower device 50 to be rotated or to be angled relative to the bed 12.

The user may operate a control panel 90 (FIG. 4) equipped on the wall to control the HVAC unit 16. Specifically, the user may manipulate a set temperature, a quantity of air, and/or the like. The HVAC unit 16 may manipulate the door 910 and/or 920 and may manipulate activation of the second fan 32 and/or the third fan 34 to control the quantity of air sprayed from the air shower device 50.

Referring to FIG. 7, the air shower device 50 may draw conditioned air from the flexible duct 70 and may enable to distribute the conditioned air throughout the internal space 54a in both the longitudinal and horizontal directions. Thus, the air shower device 50 may enable to spray conditioned air directly onto the user. As shown by the dotted lines, the sprayed conditioned air may form an air-conditioned region localized to surround the user.

After the user takes a rest, the user may fold the air shower device 50 onto the wall again to be in the state of FIG. 4.

The configuration may allow to close at least one of the ducts 26 and 28 when being not used and may enable to reduce air conditioner load.

### Second Embodiment

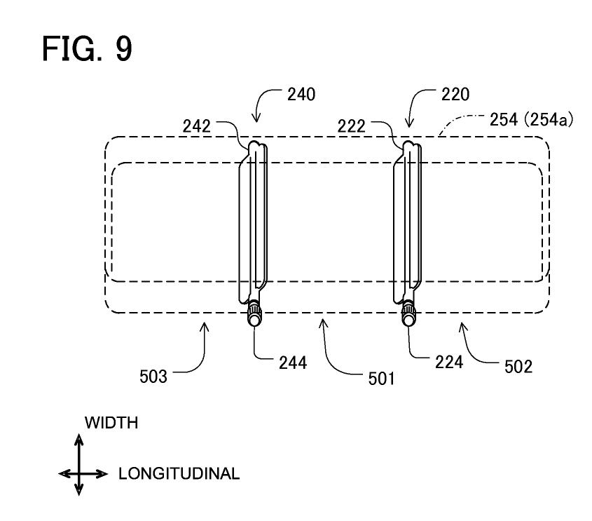

FIG. 9 schematically shows a body 254 of an air shower device of the second embodiment. In FIG. 9, illustration of the apertures and the opening is omitted. The body 254 is depicted with dotted lines to show the relative relation with components. The body 254 may accommodate two inner doors 220 and 240 configured to throttle an internal space 254a. The door 220 may be located at a boundary between the center portion 501 and the one end portion 502. The door 240 may be located at a boundary between the center portion 501 and the other end portion 503.

The doors 220 and 240 may have axes 222 and 242, respectively. The axes 222 and 242 may be rotatably supported by the body 254. The door 220 may be rotatable to control communication between the center portion 501 and the one end portion 502. The door 240 may be rotatable to control communication between the center portion 501 and the other end portion 503. The axis 222 may be equipped with a knob 224 at one axial end. The axis 242 may be equipped with a knob 244 at one axial end. A user may manipulate the knob 224 and/or 244 to rotate the door 220 and/or 240 and to control communication between the center portion 501 and the one end portion 502 and/or the other end portion 503. For example, when the user desires to reduce a quantity of air sprayed from the one end portion 502, the user may rotate the knob 224 to rotate the door 220 to throttle the internal space 254a of the body 254.

The door 220 and 240 may be electrically driven. The door 220 and 240 may be communicated with the control panel 90 and may be manipulated according to a control signal from the control panel 90.

The door 220 and/or 240 may have a sealing member at its outer periphery to seal the outer periphery with an inner periphery of the body 254. One of the door 220 and/or 240 may be omitted. The number of the doors may be three or more.

### Third Embodiment

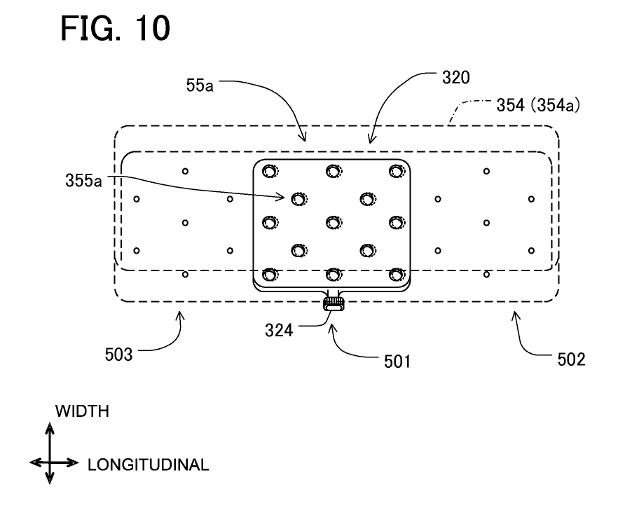

FIG. 10 schematically shows a body 354 of an air shower device of the third embodiment. In FIG. 10, illustration of the opening is omitted. The body 354 is depicted with dotted lines to show the relative relation with components. The body 354 may accommodate an inner door 320 slidable along the longitudinal direction of the body 354 to throttle the apertures 55a. Specifically, the inner door 320 may be located at the center portion 501 of the body 354. The inner door 320 may be arranged along the lower wall 65 of the body 354. The inner door 320 may be supported by a rail (not shown) formed on the lower wall 65 of the body 354. Thus, the inner door 320 may be slidable along the lower wall 65 in the longitudinal direction.

The inner door 320 may have multiple apertures 355a arranged such that the apertures 355a of the inner door 320 can be overlapped with the apertures 55a formed in the lower wall 65 of the body 354, respectively, when the inner door 320 is at a specific position. As the inner door 320 moves away from the specific position, the apertures 355a of the inner door 320 may be deviated from the corresponding apertures 55a of the body 354 thereby to throttle the corresponding apertures 55a. In this way, the inner door 320 may be slidable to control an opening area of the apertures 55a of the body 354. The inner door 320 may be equipped with a lever 324 at one end. A user may manipulate the lever 324 to slide the inner door 320 to control the opening area of the apertures 55a thereby to control a quantity of air sprayed from the apertures 55a. For example, when the user desires to reduce a quantity of air sprayed from the center portion 501 of the body 54, the user may move the lever 324 to slide the inner door 320 and to throttle the apertures 55a in the center portion 501.

The inner door 320 may be electrically driven. The inner door 320 may be communicated with the control panel 90 and may be manipulated according to a control signal from the control panel 90.

The inner door 320 may be equipped to the one end portion 502 and/or the other end portion 503 of the body 54.

### Fourth Embodiment

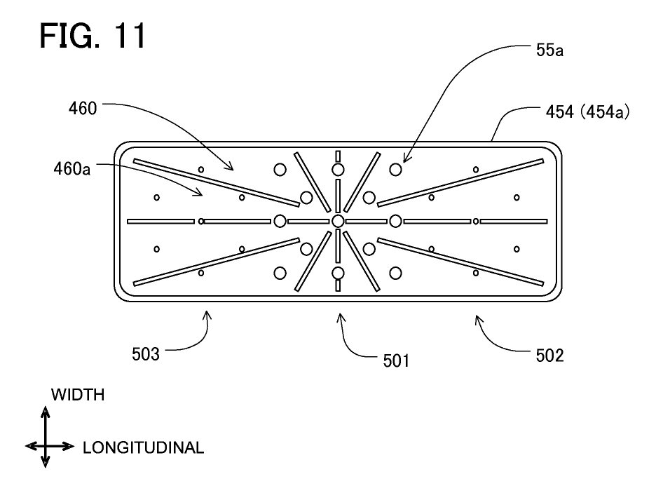

As shown in FIG. 11, a body 454 of an air shower device of the fourth embodiment has an inner wall equipped with multiple ribs 460. The ribs 460 may be projected from the inner wall in the thickness direction to form multiple air passages 460a to extend radially from the opening 53a (FIG. 6) at the center portion 501 of the body 454.

The body 454 may be configured to draw conditioned air through the air passages 460a formed with the ribs 460 radially outward from the opening 53a at the center of the body 454. Thus, the body 454 may be configured to distribute the conditioned air from the center of the body 454 radially outward.

### Fifth Embodiment

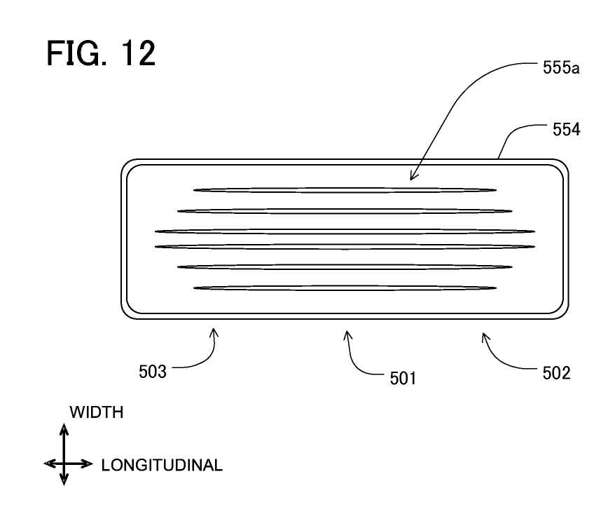

The apertures may employ various shapes. As shown in FIG. 12, a body 554 of an air shower device of the fifth embodiment may have an inner wall having multiple apertures 555a. Each of the apertures 555a may be an elongated slit extending in the longitudinal direction. The apertures 555a may be arranged along the width direction. In the example, the apertures 555a may become shorter from the center to ends in the width direction.

### Sixth Embodiment

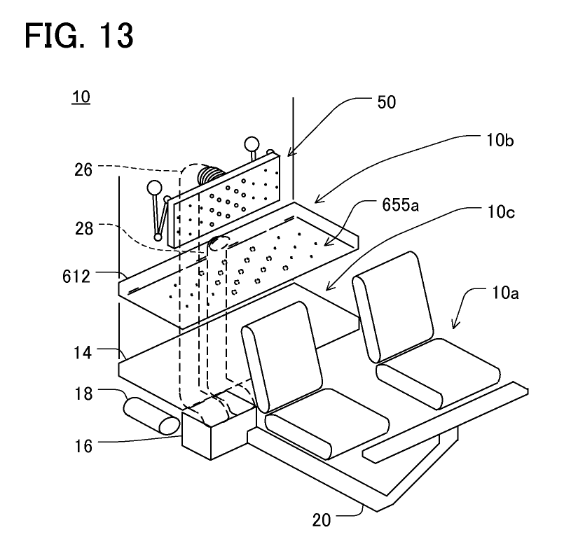

The air shower device may employ various configurations. For example, as shown in FIG. 13, an upper bed (air shower bed) 612 may function as the air shower device. The upper bed 612 may be hollow and may be connected with the duct 28. The upper bed 612 may be secured on the wall and may be horizontally installed. The upper bed 612 may be reinforced with metallic frames to bear a weight of a user. The upper bed 612 may be furnished with a cushion and/or a pillow and may be covered with fabric or leather. The upper bed 612 may have a structure similar to or identical to the air shower device according to one of the above-described embodiments. The upper bed 612 may be provided as an after market product. The upper bed 612 may be connected with the corresponding one of the ducts 26 and 28 by using an adaptor attachment and/or a flexible duct. The duct 26 and/or 28 may be of, for example, a ready-made car.

### Seventh to Ninth Embodiments

The body of the air shower device may employ various shapes to form various internal spaces.

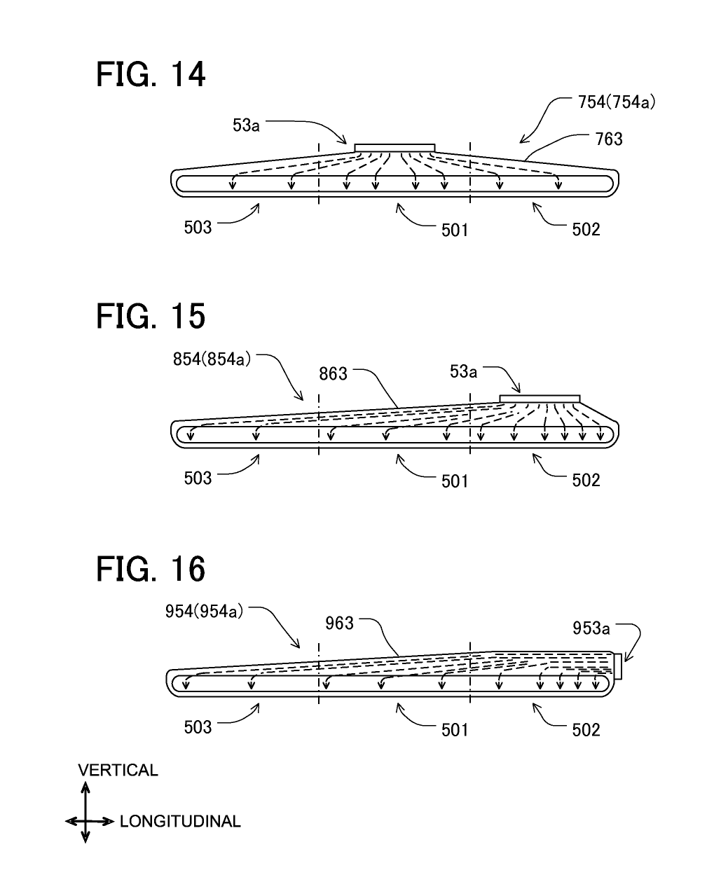

As shown in FIG. 14, a body 754 may have an upper wall 763 slightly protruded at the center portion 501. In the example, the upper wall 763 may be in a pyramid shape to reduce in the internal space 754a from the center portion 501 toward both the one end portion 502 and the other end portion 503. The center portion 501 may define the opening 53a.

As shown in FIG. 15, a body 854 may have an upper wall 863 slightly protruded at the one end portion 502. In the example, the upper wall 863 may be in an eccentric pyramid shape to reduce in the internal space 854a from the one end portion 502 through the center portion 501 toward the other end portion 503. The one end portion 502 may define the opening 53a.

As shown in FIG. 16, a body 954 may have an upper wall 963 slightly protruded at the one end portion 505. In the example, the upper wall 863 may be in an eccentric pyramid shape to reduce in the internal space 954a from the one end portion 502 through the center portion 501 toward the other end portion 503. The one end portion 502 may define an opening 953a at a lateral side of the one end portion 502.

In the examples of FIGS. 14 to 16, the body may reduce in internal space from the opening toward the farther region. Airflow from the opening may decrease in velocity due to pressure loss through the internal space. In the examples, the internal space may reduce toward the farther region correspondingly to decrease in velocity and in a quantity of airflow thereby to enable the airflow to be distributed to the farther region uniformly.

### Other Embodiment

The HVAC unit 16 may be located at various positions in the vehicle other than the position under the lower bed 14. The HVAC unit 16 may be located under a dashboard of the vehicle. In addition to the HVAC unit 16, an additional HVAC unit may be equipped in the vehicle for, for example, the front passenger compartment.

The opening 53a may be located in one end portion 502 of the body 54, which is other than the center portion 501 and the other end portion 503 of the body 54. In this case, the apertures 55a may be distributed densely in the center portion 501 and the other end portion 503 of the body 54 and may be distributed sparsely in the one end portion 502. Alternatively, in this case, the apertures 55a may be distributed sparsely in the center portion 501 and the other end portion 503 of the body 54 and may be distributed densely in the one end portion 502. The one end portion 502 may correspond to the head of a user.

The control panel 90 may be wired with or wirelessly communicated with the HVAC unit 16. The control panel 90 may be equipped to the air shower device 50.

The third embodiment may be combined with the second embodiment to include the inner door 320 and at least one of the inner doors 220 and 240 in the body 54.

The upper bed 12 and the air shower device 50 for the upper bed 12 may be omitted.

The air shower device 50 may be equipped with an electric heater and/or an electric cooler to heat and/or cool air conducted through the air shower device 50.

The wording of the upper and the lower do not limit the position of the relevant components. The components in the embodiments may be in various positions.

At least one of the ducts 26 and 28 may be in the cabin.

It should be appreciated that while the processes of the embodiments of the present disclosure have been described herein as including a specific sequence of steps, further alternative embodiments including various other sequences of these steps and/or additional steps not disclosed herein are intended to be within the steps of the present disclosure.

While the present disclosure has been described with reference to preferred embodiments thereof, it is to be understood that the disclosure is not limited to the preferred embodiments and constructions. The present disclosure is intended to cover various modification and equivalent arrangements. In addition, while the various combinations and configurations, which are preferred, other combinations and configurations, including more, less or only a single element, are also within the spirit and scope of the present disclosure.

What is claimed is:

1. An air shower device comprising:
a body being hollow and defining an internal space, wherein
the body has an upper wall and a lower wall, which are opposed to each other,
the upper wall has an opening extending though the upper wall,
the lower wall has a plurality of apertures extending though the lower wall, and
the body is configured to draw air from the opening to conduct the air through the internal space and to spray the air from the internal space through the apertures to an outside of the body.

2. The air shower device of claim 1, wherein
the body is in a flat planer shape extending in width and longitudinal directions, and
the body is configured to conduct the air through the internal space in the width and longitudinal directions.

3. The air shower device of claim 1, wherein
the upper portion has a coupler configured to be coupled with a support arm.

4. The air shower device of claim 1, wherein
the opening is configured to be coupled with a duct.

5. The air shower device of claim 1, wherein
the apertures are distributed densely in a center portion of the body and are distributed sparsely in a portion other than the center portion of the body.

6. The air shower device of claim 1, wherein
the apertures are distributed densely in one end portion of the body and are distributed sparsely in a portion other than the one end portion of the body.

7. The air shower device of claim 1, wherein
the opening is located in a center portion of the body

8. The air shower device of claim 1, wherein
the opening is located in one end portion of the body, and
the apertures are distributed densely in a portion other than the one end portion of the body and are distributed sparsely in the one end portion.

9. The air shower device of claim 1, wherein
the body has a door configured to throttle the internal space.

10. The air shower device of claim 9, wherein
the door is rotational about an axis to throttle the internal space.

11. The air shower device of claim 1, wherein
the body has a door slidable along a longitudinal direction of the body to throttle the apertures.

12. The air shower device of claim 1, wherein
the body has an upper portion and a lower portion, which are combined to each other to form the internal space therebetween,
the upper portion is in a bottomed tray shape having the upper wall,
the lower portion is in a bottomed tray shape having the lower wall,
the upper wall is substantially flat, and
the lower wall is substantially flat.

13. The air conditioning device of claim 1, wherein
the upper wall is protruded at one of a center portion and one end of the body, and
the opening is located at the one of the center portion of the body and the one end of the body.

14. An air conditioning device comprising:
an air conditioning unit; and
an air shower device connected with the air conditioning unit, wherein
the air shower device includes a body being hollow and defining an internal space,
the body has an upper wall and a lower wall, which are opposed to each other,
the upper wall has an opening extending though the upper wall,
the lower wall has a plurality of apertures extending though the lower wall, and
the body is configured to draw air from the opening to conduct the air through the internal space and to spray the air from the internal space through the apertures to an outside of the body.

15. The air conditioning device of claim 14, wherein
the air shower device is supported by a wall via a support arm,
the support arm enables the air shower device to be folded on the wall and to be placed along the wall, and
the support arm enables the air shower device to be unfolded from the wall and to be extended from the wall.

16. The air conditioning device of claim 14, wherein
the opening is coupled with a duct connected with the air conditioning unit, and
the duct is expandable or retractable.

17. An air shower bed comprising:
a body being hollow and defining an internal space, wherein
the body has an upper wall and a lower wall, which are opposed to each other,
the upper wall has an opening extending though the upper wall,
the lower wall has a plurality of apertures extending though the lower wall,
the body is configured to draw air from the opening to conduct the air through the internal space and to spray the air from the internal space through the apertures to an outside of the body, and
the body is configured to enable a user to lie on the bed.
